(19) United States
(12) Patent Application Publication
(10) Pub. No.: US 2024/0375007 A1
(43) Pub. Date: Nov. 14, 2024

(54) INTERACTIVE PROCESSING METHOD AND APPARATUS FOR VIRTUAL SCENE, ELECTRONIC DEVICE, AND STORAGE MEDIUM

(71) Applicant: Tencent Technology (Shenzhen) Company Limited, Shenzhen (CN)

(72) Inventors: Mutian SHI, Shenzhen (CN); Mengyuan ZHANG, Shenzhen (CN)

(73) Assignee: Tencent Technology (Shenzhen) Company Limited, Shenzhen (CN)

(21) Appl. No.: 18/771,935

(22) Filed: Jul. 12, 2024

Related U.S. Application Data
(63) Continuation of application No. PCT/CN2023/114571, filed on Aug. 24, 2023.

(30) Foreign Application Priority Data
Sep. 23, 2022 (CN) 202211165271.3

(51) Int. Cl. A63F 13/58; A63F 13/2145; A63F 13/52

(52) U.S. Cl. CPC A63F 13/58; A63F 13/2145; A63F 13/52

(57) ABSTRACT

In an interactive processing method, a virtual scene is displayed by an electronic device. The virtual scene includes a first virtual object. An identifier of at least one second virtual object is displayed in response to a clicking/tapping operation on a skill control of the first virtual object. An identifier of at least one target second virtual object selected by the first sliding operation is indicated in response to a first sliding operation for the identifier of the at least one second virtual object. The first sliding operation being performed by maintaining contact of the clicking/tapping operation. The first virtual object to release at least one target skill at a release position of the first sliding operation is controlled. The at least one target skill being a skill possessed by the at least one second virtual object.

### RELATED APPLICATIONS

The present application is a continuation of International Application No. PCT/CN2023/114571, filed Aug. 24, 2023, which claims priority to Chinese Patent Application No. 202211165271.3, filed on Sep. 23, 2022. The entire disclosures of the prior applications are hereby incorporated by reference.

### FIELD OF THE TECHNOLOGY

The present application relates to the field of computer human-computer interaction technologies, including to an interactive processing method and apparatus for a virtual scene, an electronic device, and a storage medium.

### BACKGROUND OF THE DISCLOSURE

The human-computer interaction technology of a virtual scene based on graphics processing hardware can implement, based on practical application requirements, a diversified interaction among virtual objects controlled by users or artificial intelligence, and has a wide practical value. For example, in a virtual scene such as a game, a real battle process between the virtual objects can be simulated.

A strategy card game is used as an example. Some virtual objects have special skills, which are divided into a “common skill” and a “stealing skill”. The common skill may be released by normally dragging a skill card once. However, the stealing skill needs to be released by using two operations: First operation: Select a stealing target. Second operation: Select a releasing target after the stealing is completed. In other words, the whole process of releasing the stealing skill requires two clicking/tapping operations and one dragging operation, which results in low operation efficiency and a low success rate.

### SUMMARY

This disclosure provides an interactive processing method and apparatus for a virtual scene, an electronic device, a computer-readable storage medium, and a computer program product, which can improve operation efficiency of skill release.

An aspect of this disclosure provides an interactive processing method for a virtual scene. In the method, a virtual scene is displayed by an electronic device. The virtual scene includes a first virtual object. An identifier of at least one second virtual object is displayed in response to a clicking/tapping operation on a skill control of the first virtual object. An identifier of at least one target second virtual object selected by the first sliding operation is indicated in response to a first sliding operation for the identifier of the at least one second virtual object. The first sliding operation being performed by maintaining contact of a skill control of the first virtual object. The first virtual object to release at least one target skill at a release position of the first sliding operation is controlled. The at least one target skill being a skill possessed by the at least one second virtual object.

An aspect of this disclosure provides an interactive processing apparatus for a virtual scene, including processing circuitry is provided. The processing circuitry is configured to display a virtual scene. The virtual scene includes a first virtual object. The processing circuitry is configured to an identifier of at least one second virtual object is displayed in response to a clicking/tapping operation on a skill control of the first virtual object. The processing circuitry is configured to indicate an identifier of at least one target second virtual object selected by the first sliding operation in response to a first sliding operation for the identifier of the at least one second virtual object. The first sliding operation being performed by maintaining contact of a skill control of the first virtual object. The processing circuitry is configured to control the first virtual object to release at least one target skill at a release position of the first sliding operation in response to the first sliding operation being released. The at least one target skill being a skill possessed by the at least one second virtual object.

An aspect of this disclosure provides an electronic device, including:
a memory, configured to store an executable instruction; and
a processor, configured to implement, when executing the executable instruction stored in the memory, the interactive processing method for a virtual scene according to an aspect of this application.

An aspect of this disclosure provides a computer-readable storage medium, having a computer-executable instruction stored therein, the computer-executable instruction, when executed by a processor, implementing the interactive processing method for a virtual scene according to an aspect of this application.

An aspect of this application provides a computer program product, including a computer program or a computer-executable instruction, the computer program or the computer-executable instruction, when executed by a processor, implementing the interactive processing method for a virtual scene according to an aspect of this application.

The aspects of this application have the following beneficial effects.

In response to the clicking/tapping operation for the skill control of the first virtual object, the identifier of the at least one second virtual object available for operation is displayed, and the first sliding operation is supported. The first sliding operation is performed from the contact of the clicking/tapping operation in a case that the clicking/tapping operation is maintained, thereby implementing a seamless connection between clicking/tapping and sliding, and achieving an effect of successively setting, through one sliding operation, the target second virtual object that needs to obtain a skill and the release position of the target skill. Compared with a manner of respectively setting, through a plurality of operations, the target second virtual object that needs to obtain a skill and the release position of the target skill, the number of operations is saved, and the operation efficiency and the success rate of skill release are improved.

### BRIEF DESCRIPTION OF THE DRAWINGS

FIG. 1A is a schematic diagram of an application mode of an interactive processing method for a virtual scene according to an aspect of this application.

FIG. 1B is a schematic diagram of an application mode of an interactive processing method for a virtual scene according to an aspect of this application.

FIG. 2 is a schematic structural diagram of an electronic device 500 according to an aspect of this application.

FIG. 3 is a schematic flowchart of an interactive processing method for a virtual scene according to an aspect of this application.

FIG. 4A to FIG. 4C are each a schematic diagram of an application scene of an interactive processing method for a virtual scene according to an aspect of this application.

FIG. 5A and FIG. 5B are each a schematic flowchart of an interactive processing method for a virtual scene according to an aspect of this application.

FIG. 6A to FIG. 6C are each a schematic diagram of an application scene of an interactive processing method for a virtual scene according to an aspect of this application.

FIG. 7 is a schematic flowchart of an interactive processing method for a virtual scene according to an aspect of this application.

### DETAILED DESCRIPTION

To make objectives, technical solutions, and advantages of this application clearer, this application is to be further described in detail with reference to accompany drawings. The described examples are not to be construed as a limitation on this application. All other examples obtained by a person of ordinary skill in the art without creative efforts fall within the protection scope of this application.

The examples of this application relate to related data such as user information. User permission or consent needs to be obtained when the examples of this application are applied to specific products or technologies, and collection, use, and processing of related data need to comply with relevant laws, regulations, and standards of relevant countries and regions.

In the following description, a term “first/second/ . . . ” involved is merely used for distinguishing between similar objects and does not represent a specific order of objects. “First/second/ . . . ” may be transposed for a specific order or a sequence when allowed, so that the examples of this application described herein can be implemented in an order other than those illustrated or described herein.

Unless otherwise defined, meanings of all technical and scientific terms used in this specification are the same as those usually understood by a person skilled in the art to which this application belongs. The terms used in this specification are merely intended to describe objectives of the examples of this application, but are not intended to limit this application.

1) In response to: The expression “in response to” is used for indicating a condition or a status on which one or more to-be-performed operations depend. When the condition or the status on which the to-be-performed operation depends is satisfied, the one or more operations may be performed in real time or with a set delay. Unless otherwise specified, a sequence in which a plurality of operations are performed is not limited.

2) Virtual scene: It is a scene displayed (or provided) when an application runs on a terminal device. The virtual scene may be a simulation environment for the real world, or may be a semi-simulation and semi-fiction virtual environment, and may also be a purely fictional virtual environment. The virtual scene may be any one of a two-dimensional virtual scene, a 2.5-dimensional virtual scene, or a three-dimensional virtual scene, and the dimensions of the virtual scene are not limited in the examples of this application. For example, the virtual scene may include sky, land, ocean, and the like. The land may include environmental elements such as desert and city, and a user may control a virtual object to move in the virtual scene.

3) Virtual object: The virtual objects are images of various people and things that may interact in a virtual scene, or movable objects in the virtual scene. The movable object may be a virtual character, a virtual animal, a cartoon character, and the like, for example, a character and an animal displayed in a virtual scene. The virtual object may be a virtual image for representing a user in a virtual scene. The virtual scene may include a plurality of virtual objects, and each virtual object has a shape and a volume in the virtual scene, and occupies some space in the virtual scene.

4) Scene data: It represents feature data of a virtual scene. For example, the scene data may be an area of a construction region in the virtual scene and a current architectural style of the virtual scene. The scene data may also include a location of a virtual building in the virtual scene, a floor area of the virtual building, and the like.

5) Client: It is an application running in a terminal device for providing various services, for example, a video playback client and a game client.

The disclosure provides an interactive processing method and apparatus for a virtual scene, an electronic device, a computer-readable storage medium, and a computer program product, which can improve operation efficiency of skill release. To make it easier to understand the interactive processing method for a virtual scene provided in this disclosure, an example implementation scenario of the interactive processing method for a virtual scene provided in the examples of this application is first described. The virtual scene in the interactive processing method for a virtual scene provided in the embodiments of this application may be outputted completely based on a terminal device or collaboratively outputted based on the terminal device and a server.

In some examples, the virtual scene may be an environment for virtual objects (such as game characters) to interact, for example, for game characters to fight in a virtual scene. By controlling actions of game characters, both parties may interact in the virtual scene, so that users can relieve pressure of life during the game.

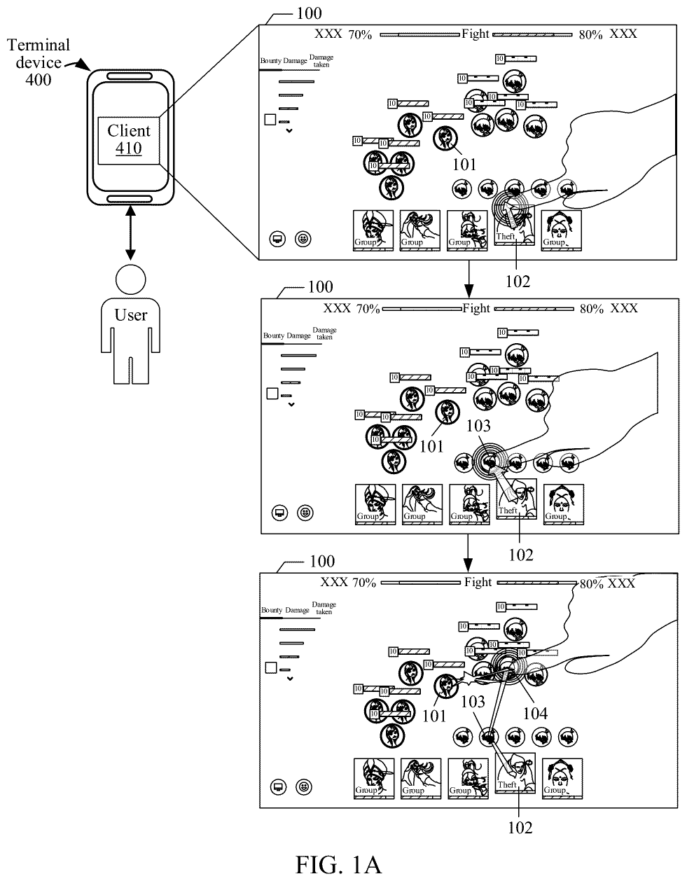

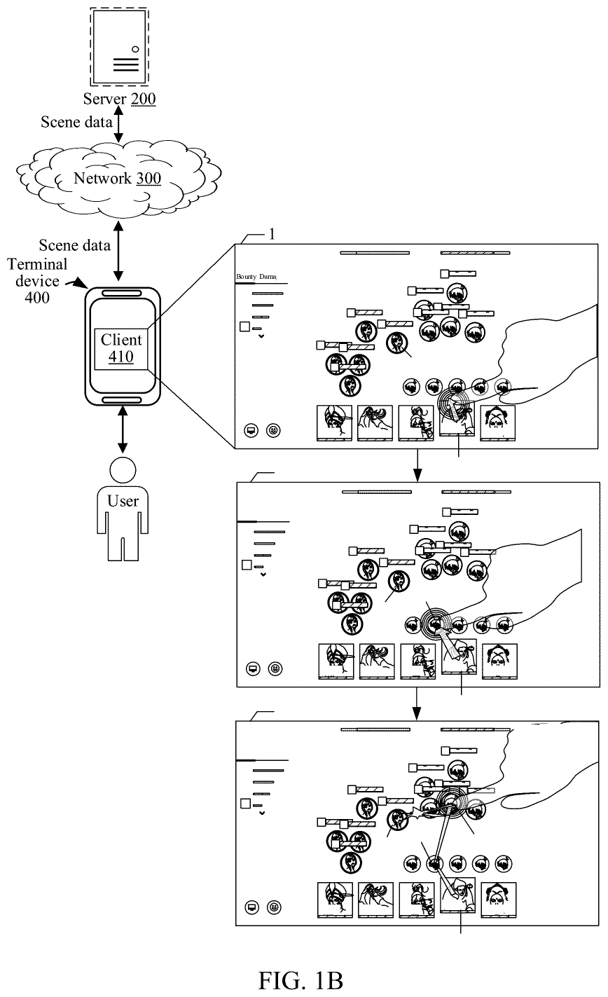

In an example, FIG. 1A is a schematic diagram of an application mode of an interactive processing method for a virtual scene according to an aspect of this application, which is applicable to some application modes of completely relying on computing power of graphics processing hardware of a terminal device 400 to complete calculation of related data of a virtual scene 100. For example, in a game in a stand-alone/an off-line mode, outputting of a virtual scene is completed through various types of terminal devices 400 such as a smart phone, a tablet computer, and a virtual reality/augmented reality device.

In an example, types of graphics processing hardware include a central processing unit (CPU) and a graphics processing unit (GPU).

When visual perception of the virtual scene 100 is formed, the terminal device 400 calculates data required for display through the graphics computing hardware, completes loading, parsing, and rendering of the displayed data, and outputs a video frame capable of forming visual perception of the virtual scene on the graphics output hardware. For example, a two-dimensional video frame is presented on a display screen of a smart phone, or a video frame with a three-dimensional display effect is projected onto lenses of augmented reality/virtual reality glasses. In addition, to enrich the perception effect, the terminal device 400 may also form one or more of auditory perception, tactile perception, motion perception, and taste perception through different hardware.

In an example, a client 410 (for example, a stand-alone game application) is run on the terminal device 400, and a virtual scene including role play is outputted during the running of the client 410. The virtual scene may be an environment for game characters to interact, which may be a plain, a street, a valley, or the like for game characters to fight, for example. The virtual scene 100 being displayed from a third-person perspective is used as an example. A first virtual object 101 is displayed in the virtual scene 100. The first virtual object 101 may be a user-controlled game character, i.e., the first virtual object 101 is controlled by a real user and is to move in the virtual scene 100 in response to an operation of the real user performed on a controller (such as a touch screen, a voice-operated switch, a keyboard, a mouse, and a joystick). For example, when the real user moves the joystick to the right, the first virtual object 101 is to move to the right in the virtual scene 100, or may keep still, jump, and control the first virtual object 101 to perform a shooting operation.

For example, skill controls (for example, skill cards) respectively corresponding to a plurality of virtual objects are displayed in the virtual scene 100. When the client 410 receives a clicking/tapping operation performed by a user for a skill control 102 corresponding to the first virtual object 101, an identifier (for example, an avatar) of at least one second virtual object (i.e., a virtual object from which the user wants to steal a skill) is displayed. Next, the client 410 is configured to emphasize, in response to a first sliding operation for the identifier of the at least one second virtual object, an identifier of at least one target second virtual object selected by the first sliding operation, to represent that the identifier of the at least one target second virtual object is in a selected state. The first sliding operation is performed from a contact of the clicking/tapping operation in a case that the clicking/tapping operation is maintained. For example, assuming that the user slides up while maintaining the clicking/tapping operation, and a sliding trajectory passes through an identifier 103 of a game character B (i.e., the target second virtual object), the identifier 103 of the game character may be emphasized, to represent that the identifier 103 of the game character B is in a selected state (i.e., the user needs to control the first virtual object 101 to steal a skill possessed by the game character B). Then the client 410 is configured to control, in response to the first sliding operation being released, the first virtual object 101 to release a target skill at a release position 104 of the first sliding operation. The target skill is a skill possessed by the game character B. In this way, the user may simultaneously complete the stealing and release of the skill through one sliding operation, which improves operation efficiency of skill release.

In another implementation scenario, FIG. 1B is a schematic diagram of an application mode of an interactive processing method for a virtual scene according to an aspect of this application, which is applied to a terminal device 400 and a server 200, and is applicable to an application mode of relying on computing power of a server 200 to complete calculation of the virtual scene and outputting a virtual scene at the terminal device 400.

Visual perception of the virtual scene 100 being formed is used as an example. The server 200 calculates display data (such as scene data) related to the virtual scene and transmits the data to the terminal device 400 through a network 300. The terminal device 400 relies on graphics computing hardware to complete loading, parsing, and rendering of the calculated display data, and relies on the graphics output hardware to output a virtual scene to form visual perception. For example, a two-dimensional video frame may be presented on a display screen of a smart phone, or a video frame with a three-dimensional display effect is projected onto lenses of augmented reality/virtual reality glasses. For the perception in the form of the virtual scene, a virtual scene may be outputted by means of the corresponding hardware of the terminal device 400, for example, using a microphone to form auditory perception, and using a vibrator to form haptic perception.

In an example, a client 410 (for example, an online game application) is run on the terminal device 400, and interacts with other users through a connection server 200 (for example, a game server), and the terminal device 400 outputs the virtual scene 100 of the client 410. The virtual scene 100 being displayed from a third-person perspective is used as an example. A virtual object 101 is displayed in the virtual scene 100. The virtual object 101 may be a user-controlled game character, namely, the virtual object 101 is controlled by a real user and is to move in the virtual scene 100 in response to an operation performed by the real user for a controller (for example, a touch screen, a voice-operated switch, a keyboard, a mouse, and a joystick). For example, when the real user moves the joystick to the right, the virtual object 101 is to move to the right in the virtual scene 100, or may keep still, jump, and control the virtual object 101 to perform a shooting operation.

For example, skill controls (for example, skill cards) respectively corresponding to a plurality of virtual objects are displayed in the virtual scene 100. When the client 410 receives a clicking/tapping operation performed by a user for a skill control 102 corresponding to the first virtual object 101, an identifier (for example, an avatar) of at least one second virtual object (i.e., a virtual object from which the user wants to steal a skill) is displayed. Next, the client 410 is configured to emphasize, in response to a first sliding operation for the identifier of the at least one second virtual object, an identifier of at least one target second virtual object selected by the first sliding operation (namely, which represents that the identifier of the at least one target second virtual object is in a selected state). The first sliding operation is performed from a contact of the clicking/tapping operation in a case that the clicking/tapping operation is maintained. For example, assuming that the user slides up while maintaining the clicking/tapping operation, and a sliding trajectory passes through an identifier 103 of a game character B (i.e., the target second virtual object), the identifier 103 of the game character may be emphasized, to represent that the identifier 103 of the game character B is in a selected state (i.e., the user wants to control the first virtual object 101 to steal a skill possessed by the game character B). Then the client 410 is configured to control, in response to the first sliding operation being released, the first virtual object 101 to release a target skill at a release position 104 of the first sliding operation. The target skill is a skill possessed by the game character B. In this way, the user may simultaneously complete the stealing and release of the skill through one sliding operation, which improves operation efficiency of skill release.

In an example, the terminal device 400 may also implement the interactive processing method for a virtual scene provided in this disclosure by running a computer program. For example, the computer program may be a native program or a software module in an operating system; may be a native application (APP), i.e., a program that needs to be installed in the operating system to run, such as a strategy card game APP (i.e., the foregoing client 410); may be an applet, i.e., a program that only needs to be downloaded into a browser environment to run; and may also be a game applet that can be embedded in any APP. In a word, the foregoing computer program may be any form of application, module, or plug-in.

A computer program being an application program is used as an example. During actual implementation, an application supporting a virtual scene is installed and run in the terminal device 400. The application may be any one of a first-person shooting game (FPS), a third-person shooting game, a virtual reality application program, a three-dimensional map program, the strategy card game, or a multiplayer shootout survival game. A user uses the terminal device 400 to operate a virtual object located in the virtual scene to perform an activity. The activity includes but is not limited to at least one of adjusting a body posture, crawling, walking, running, riding, jumping, driving, pickup, shooting, attacking, throwing, and building a virtual building. For example, the virtual object may be a virtual character, such as a simulated character or a cartoon character.

In an aspect of this disclosure cloud technology is implemented. The cloud technology is a hosting technology that unifies a series of resources such as hardware, software, and a network in a wide area network or a local area network to realize data computing, storage, processing, and sharing.

The cloud technology is a generic term of a network technology, an information technology, an integration technology, a management platform technology, and an application technology based on application of a cloud computing business model. The resources may form a resource pool and are used on demand, which is flexible and convenient. A cloud computing technology is to become an important support. Background services of a technology network system require a lot of computing and storage resources.

For example, the server 200 in FIG. 1B may be an independent physical server, or may be a server cluster formed by a plurality of physical servers or a distributed system, and may also be a cloud server providing basic cloud computing services such as cloud service, a cloud database, cloud computing, a cloud function, cloud storage, a network service, cloud communication, a middleware service, a domain name service, a security service, a content delivery network (CDN), a big data, and artificial intelligence platform. The terminal device 400 may be a smart phone, a tablet computer, a notebook computer, a desktop computer, a smart speaker, a smart watch, an on-board terminal, or the like, which is not limited thereto. The terminal device 400 and the server 200 may be directly or indirectly connected in a manner of wired or wireless communication, which is not limited in this aspect of this application.

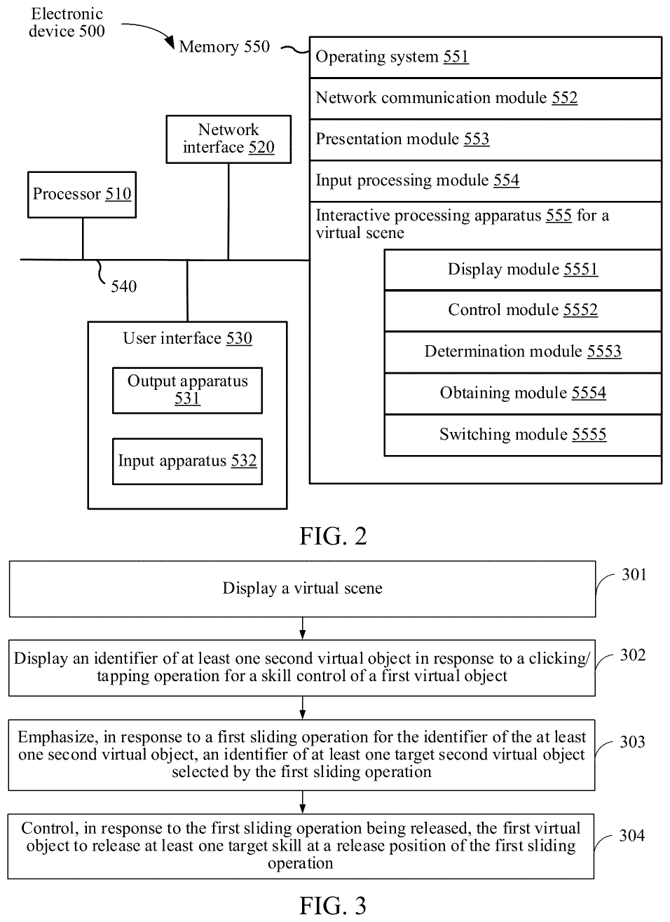

A structure of the electronic device provided in the aspects of this application continues to be described below. An example in which the electronic device is a terminal device is used. FIG. 2 is a schematic structural diagram of an electronic device 500 according to an aspect of this application. The electronic device 500 shown in FIG. 2 includes at least one processor 510, a memory 550, at least one network interface 520, and a user interface 530. Various components in the electronic device 500 are coupled together through a bus system 540. The bus system 540 is configured to implement connection and communication between the components. In addition to a data bus, the bus system 540 also includes a power bus, a control bus, and a status signal bus. However, for the sake of clarity, various buses are marked as the bus system 540 in FIG. 2.

Processing circuitry, such as the processor 510 may be an integrated circuit chip with a signal processing capability, for example, a general-purpose processor, a digital signal processor (DSP), another programmable logic device, a discrete gate or a transistor logic device, a discrete hardware component, or the like. The general-purpose processor may be a microprocessor, any conventional processor, or the like.

The user interface 530 includes one or more output apparatuses 531 that enable presentation of media content, including one or more speakers and/or one or more visual display screens. The user interface 530 also includes one or more input apparatuses 532, including user interface components that facilitate user input, such as a keyboard, a mouse, a microphone, a touch screen display, a camera, and another input button and control.

The memory 550 is removable, non-removable, or a combination thereof. For example, hardware device includes a solid-state memory, a hard disk driver, an optical disk driver, and the like. In some examples, the memory 550 includes one or more storage devices at a physical location away from the processor 510.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in this example of this application is intended to include any suitable type of memory.

In some examples, the memory 550, such as a non-transitory computer-readable storage medium, can store data to support various operations. Examples of the data include a program, a module, and a data structure or a subset or a superset thereof. An example description is given below.

An operating system 551 includes system programs configured to process various basic system services and perform hardware-related tasks, for example, a framework layer, a core library layer, and a driver layer, which are used for implementing various basic services and process hardware-based tasks.

A network communication module 552 is configured to reach another computing device through one or more (wired or wireless) network interfaces 520. For example, network interface 520 includes a Bluetooth interface, a wireless compatibility authentication (Wi-Fi) interface, a universal serial bus (USB) interface, and the like.

A presentation module 553 is configured to enable presentation of information (for example, a user interface for operation of a peripheral device and display of content and information) through one or more output apparatuses 531 (for example, a display screen and a speaker) associated with the user interface 530.

An input processing module 554 is configured to detect one or more user inputs or interactions from one of the one or more input apparatuses 532 and translate the detected inputs or interactions.

In some examples, an apparatus provided in this disclosure may be implemented by software. FIG. 2 shows an interactive processing apparatus 555 for a virtual scene stored in the memory 550, which may be software in the form of programs and plug-ins, including the following software modules: a display module 5551, a control module 5552, a determination module 5553, an obtaining module 5554, and a switching module 5555. The modules are logical and therefore may be arbitrarily combined or further split based on implemented functions. In FIG. 2, for convenience of expression, all the foregoing modules are shown at one time, but it is not to be deemed that the implementation in which the interactive processing apparatus 555 for a virtual scene may include only the display module 5551 and the control module 5552 is excluded, and functions of the modules are to be described below.

The interactive processing method for a virtual scene provided in the examples of this application is to be described in detail below in combination with example application and implementation of the terminal device provided in the examples of this application.

FIG. 3 is a schematic flowchart of an interactive processing method for a virtual scene according to an aspect of this application. A description is to be given with reference to operations shown in FIG. 3.

The method shown in FIG. 3 may be performed by using various forms of computer programs run on a terminal device, which is not limited to a client, and may also be the foregoing operating system, software modules, scripts, and applets, for example. Therefore, the following example of the client is not to be regarded as a limitation on the disclosure. In addition, for convenience of expression, no specific distinction is made between the terminal device and the client running on the terminal device below.

Operation 301: Display a virtual scene.

The virtual scene herein may include skill controls (for example, skill controls displayed in the form of cards, which are referred to as skill cards for short below) respectively corresponding to a plurality of virtual objects.

In an aspect, a client (for example, a strategy card game APP) supporting the virtual scene is installed on the terminal device. When a user opens the client (for example, the terminal device receives a clicking/tapping operation performed by the user on an icon corresponding to the strategy card game APP presented on a homescreen) installed on the terminal device, and the terminal device runs the client, the virtual scene may be displayed on a human-computer interaction interface of the client. The virtual scene includes the skill cards respectively corresponding to the plurality of virtual objects.

In an aspect, on the human-computer interaction interface of the client, the virtual scene may be displayed from a first-person perspective (for example, the user plays a role of the virtual object in a game from the perspective of the user); or the virtual scene may be displayed from a third-person perspective (for example, a game is played with the user chasing the virtual object in the game); and the virtual scene may also be displayed from a bird's-eye view. The foregoing different perspectives may be switched randomly.

In an example, the first virtual object may be an object controlled by a current user in a game. Certainly, the virtual scene may also include another virtual object, for example, a virtual object that may be controlled by another user or by a robot program. Virtual objects may be divided into any one of a plurality of camps, a hostile relationship or a cooperative relationship may exist between the camps, and one or both of the foregoing relationships may exist between the camps in the virtual scene.

A virtual scene being displayed from the first-person perspective is used as an example. The displaying the virtual scene on the human-computer interaction interface may include: determining a field of view region of the first virtual object based on a viewing location and a field of view of the first virtual object in a complete virtual scene, and presenting a part of the virtual scene in the field of view region in the complete virtual scene, that is, the displayed virtual scene may be a part of the virtual scene relative to a panoramic virtual scene. Since the first-person perspective is a viewing perspective that can give the user the maximum impact, immersive perception of the user during operation can be realized.

A virtual scene being displayed from the bird's-eye view is used as an example. The displaying the virtual scene on the human-computer interaction interface may include: presenting a part of the virtual scene corresponding to a zooming operation on the human-computer interaction interface in response to the zooming operation for the panoramic virtual scene, i.e., the displayed virtual scene may be a part of the virtual scene relative to the panoramic virtual scene. In this way, the operability of the user in the operation process can be improved, so that the efficiency of human-computer interaction can be improved.

Operation 302: Display an identifier of at least one second virtual object in response to a clicking/tapping operation for a skill control of a first virtual object.

In an aspect, the skill control of the first virtual object may have two different modes, which are respectively an expanded mode and a self mode. The expanded mode is a mode in which the first virtual object is controlled to use a skill possessed by another virtual object (for example, when the first virtual object and a target second virtual object belong to the same camp, the mode is a borrowing mode, namely, the first virtual object may borrow a skill of the target second virtual object with the permission of the target second virtual object; and when the first virtual object and the target second virtual object belong to different camps, the mode is a theft mode, namely, the first virtual object may use the skill possessed by the target second virtual object without the permission of the target second virtual object). The self mode is a mode in which the first virtual object is controlled to release the skill possessed by the first virtual object. An example in which the first virtual object and the target second virtual object belong to different camps is used. When a current mode of the skill control of the first virtual object is the self mode, before displaying the identifier of the at least one second virtual object in response to a clicking/tapping operation for the skill control of the first virtual object, the terminal device may also perform the following process: switching the skill control of the first virtual object from the self mode to the theft mode in response to a mode switching operation (for example, a switch button may be displayed on the skill control, and when a clicking/tapping operation performed by the user for the switch button is received, the mode of the skill control may be switched) for the skill control of the first virtual object.

For example, the first virtual object is a game character A is used. It is assumed that the game character A has special skills, including a “common skill” and a “stealing skill”. Correspondingly, the skill control of the game character A may have two different modes, which are respectively the theft mode (corresponding to the “stealing skill”) and the self mode (corresponding to the “common skill”). In other words, when the user wants to control the game character A to release the “stealing skill”, the user first needs to switch the mode of the skill control of the game character A to the theft mode, so as to control the game character A to release the “stealing skill”. In this way, different modes are reused through the same skill control, which can effectively reduce space occupied by the skill control in the virtual scene and improve game experience of the user.

In an aspect, during the display of the identifier (for example, an avatar or a name) of the at least one second virtual object, the terminal device may also perform the following processes: emphasizing (for example, highlighting, flickering display, and adding a surrounding box) the skill control of the first virtual object to represent that the skill control of the first virtual object is in a selected state, and displaying a guide identifier (for example, a guide icon, including an arrow and a caption), the guide identifier being configured to guide selection of the identifier of the at least one second virtual object. In this way, the selection of the identifier of the at least one second virtual object by the user is facilitated by presenting the guide identifier.

The second virtual object in this disclosure is a general term of the virtual object from which the first virtual object wants to steal the skill, rather than specifically referring to a virtual object in the virtual scene. For example, it is assumed that a first camp and a second camp that fight against each other exist in the virtual scene, and the first virtual object belongs to the first camp. If the first virtual object wants to steal the skill possessed by the virtual object included in the second camp, the virtual object included in the second camp may be referred to as a second virtual object. Moreover, the skill that the first virtual object steals from the second virtual object may be a skill that the first virtual object does not possess, or may be a skill that the first virtual object possesses. For example, assuming that the first virtual object has a skill 1, a skill 2, and a skill 3, and the second virtual object has a skill 3, a skill 4, and a skill 5, the first virtual object may steal the skill 4 and the skill 5 of the second virtual object. In addition, since the skill of the first virtual object is limited by a cooling time and cannot be continuously released, the first virtual object may also steal the skill 3 possessed by the second virtual object when the skill 3 of the first virtual object is in the cooling time, so that the skill 3 may be immediately released, which is not limited in the examples of this application.

Operation 303: Emphasize, in response to a first sliding operation for the identifier of the at least one second virtual object, an identifier of at least one target second virtual object selected by the first sliding operation.

The first sliding operation herein is performed from a contact of the clicking/tapping operation in a case that the clicking/tapping operation is maintained.

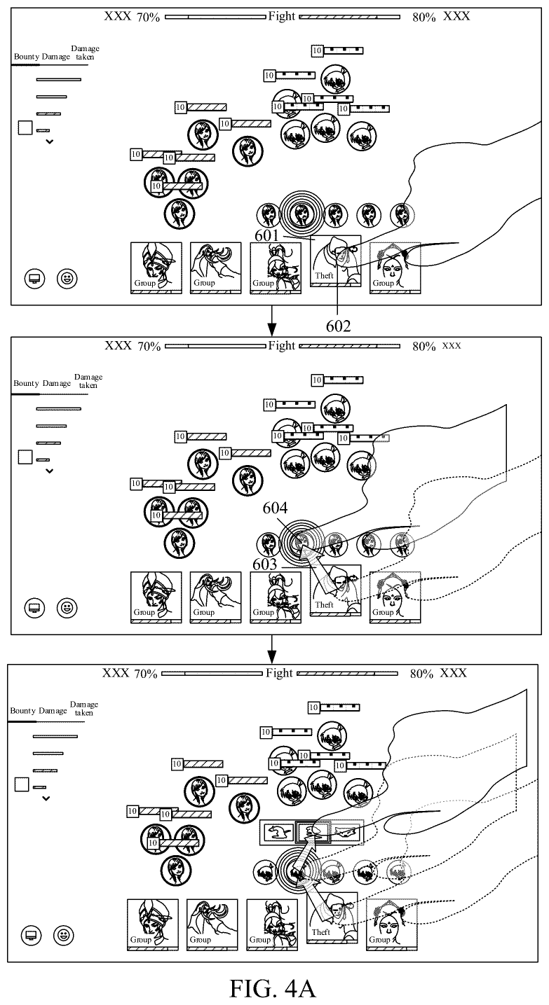

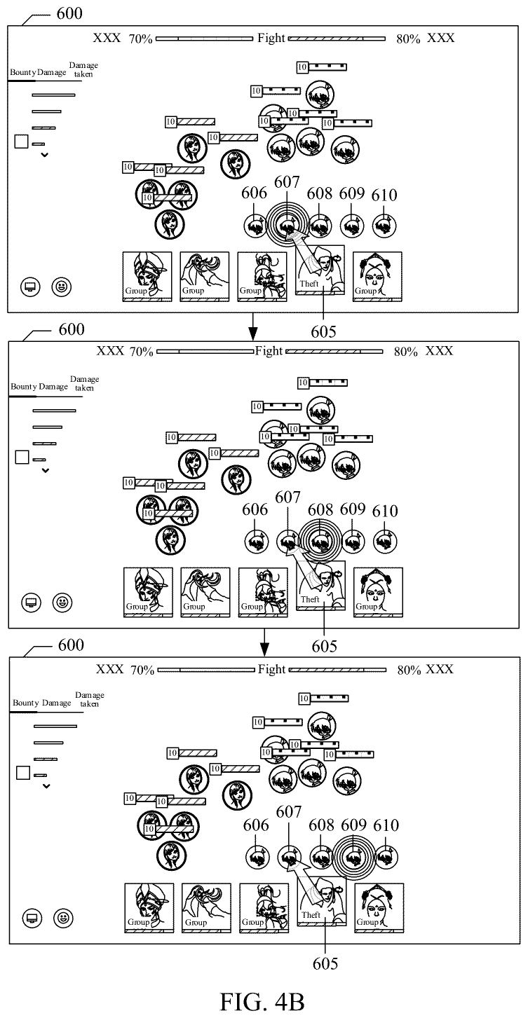

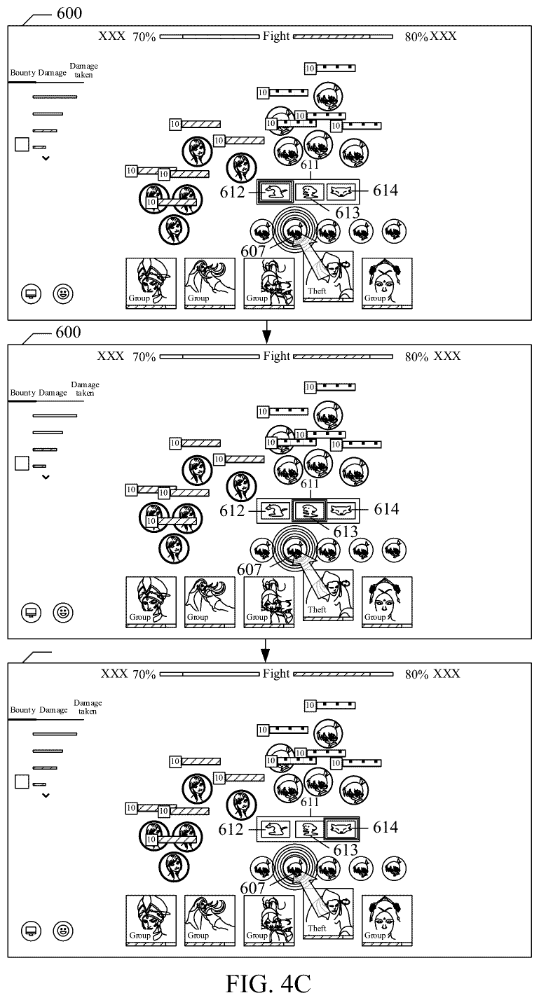

An example in which the first virtual object is a game character A is used. FIG. 4A is a schematic diagram of an application scenario of an interactive processing method for a virtual scene according to an example of this application. As shown in FIG. 4A, when a clicking/tapping operation performed by a user for a skill control 601 of the game character A is received, avatars respectively corresponding to 5 second virtual objects may be displayed. In this case, the user may perform a first sliding operation (i.e., the first sliding operation is performed by using a contact 602 of the clicking/tapping operation as a starting point) from the contact 602 of the clicking/tapping operation in a case that the clicking/tapping operation is maintained. In addition, assuming that a sliding trajectory of the first sliding operation triggered by the user passes through an avatar 604 of a game character C, a sliding trajectory 603 of the first sliding operation may be displayed by using the contact 602 of the clicking/tapping operation as the starting point.

In an aspect, before emphasizing the identifier of the at least one target second virtual object selected by the first sliding operation, the terminal device may also perform the following process: determining, as the identifier of the at least one target second virtual object selected by the first sliding operation, the identifier (for example, the avatar) of the at least one second virtual object through which the sliding trajectory of the first sliding operation passes.

For example, assuming that the identifiers of the 5 second virtual objects are displayed when the terminal device receives a clicking/tapping operation performed by the user for a skill card of a first virtual object (for example, the game character A), assuming that the identifiers are respectively an avatar of a game character B, an avatar of a game character C, an avatar of a game character D, an avatar of a game character E, and an avatar of a game character F, and assuming that the sliding trajectory of the first sliding operation triggered by the user passes through the avatar of the game character D, the avatar of the game character D may be emphasized, to represent that the avatar of the game character D is currently in a selected state (namely, the user wants to control the game character A to steal a skill possessed by the game character D).

In an aspect, before emphasizing the identifier of the at least one target second virtual object selected by the first sliding operation, the terminal device may also perform the following process: determining, as the identifier of the at least one target second virtual object selected by the first sliding operation, the identifier of the at least one second virtual object within a closed region formed by a sliding trajectory of the first sliding operation.

For example, assuming that the identifiers of the 5 second virtual objects are displayed when the terminal device receives a clicking/tapping operation performed by the user for a skill card of a first virtual object (for example, the game character A), assuming that the identifiers are respectively an avatar of a game character B, an avatar of a game character C, an avatar of a game character D, an avatar of a game character E, and an avatar of a game character F, and assuming that the avatar of the game character D and the avatar of the game character E simultaneously exist within a closed region formed by the sliding trajectory of the first sliding operation triggered by the user (for example, assuming that the user draws a large circle surrounding the avatar of game character D and the avatar of game character E), the terminal device may emphasize the avatar of the game character D and the avatar of the game character E to represent that the avatar of the game character D and the avatar of the game character E are currently in a selected state (namely, the user wants to control the game character A to steal a skill possessed by the game character D and a skill possessed by the game character E).

In an aspect, after emphasizing the identifier of the at least one target second virtual object selected by the first sliding operation, the terminal device may also perform the following process: displaying a skill range indicator control corresponding to at least one target skill (i.e., a skill possessed by the at least one target second virtual object) with a current contact of the first sliding operation as a center, the skill range indicator control being configured to indicate a range of effect of the at least one target skill.

In an example, a display parameter different from an unaffected range may be adopted in the range of effect, for example, different color parameters and brightness parameters. Certainly, the range of effect may also be represented by a closed geometric figure such as a circle and a rectangle.

For example, an example in which the target second virtual object is the game character B is used. After the terminal device emphasizes the avatar of the game character B, the skill range indicator control corresponding to the skill (for example, the skill 2) possessed by the game character B may also be displayed with a current contact (i.e., a point contacting the human-computer interaction interface) of the first sliding operation as a center. The skill range indicator control is configured to indicate a range of effect of the skill 2. In this way, the user may clearly understand the range of effect of the stolen skill through the display of the skill range indicator control, which facilitates release of a subsequent skill.

In an aspect, when the range of effect of the at least one target skill has an adjustable attribute, the terminal device may also perform the following processes before displaying the skill range indicator control corresponding to the at least one target skill: obtaining a pressure parameter (for example, a pressure value) of the first sliding operation; and determining the range of effect of the at least one target skill based on the pressure parameter, a size of the range of effect being positively correlated (for example, positively linearly correlated or positively non-linearly correlated) with the pressure parameter.

In an example in which the target skill is the skill 2 is used. When the range of effect of the skill 2 has an adjustable attribute, for example, the range of effect of the skill 2 may be adjusted based on the pressure parameter of the first sliding operation, the terminal device may also perform the following processes before displaying the skill range indicator control corresponding to the skill 2: obtaining a pressure value of the first sliding operation; and querying a mapping relationship table based on the pressure value, and determining a queried size as the size of the range of effect of the skill 2. The mapping relationship table includes a mapping relationship between the pressure value and the size of the range of effect, and a larger pressure value indicates a larger corresponding size of the range of effect. In this way, the user may flexibly adjust the range of effect of the target skill by adjusting the pressure value of the first sliding operation, which improves game experience of the user.

In an aspect, when the range of effect of the at least one target skill has an adjustable attribute, the terminal device may also perform the following process before displaying the skill range indicator control corresponding to the at least one target skill: determining, as the range of effect of the at least one target skill, a closed region formed by the sliding trajectory of the first sliding operation in the virtual scene.

In an example in which the target skill is the skill 2 is used. When the range of effect of the skill 2 has an adjustable attribute, the terminal device may also perform the following process before displaying the skill range indicator control corresponding to the skill 2: determining, as the range of effect of the skill 2, the closed region formed by the sliding trajectory of the first sliding operation triggered by the user in the virtual scene (for example, a sand table for the virtual object to move). For example, assuming that the user draws a circle in the sand table, the circle may be used as the range of effect of the skill 2. In this way, the user may flexibly adjust the range of effect of the target skill, which improves game experience of the user.

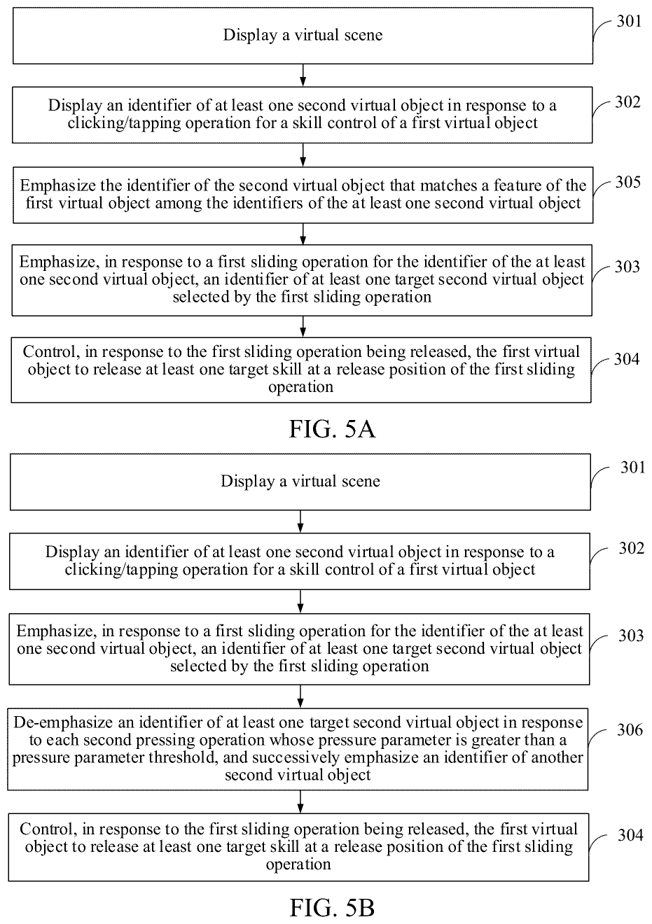

In an aspect, FIG. 5A is a schematic flowchart of an interactive processing method for a virtual scene according to an example of this application. As shown in FIG. 5A, a terminal device may also perform operation 305 shown in FIG. 5A before performing operation 303 shown in FIG. 3. A description is to be given based on operations shown in FIG. 5A.

Operation 305: Emphasize an identifier of a second virtual object that matches a feature of a first virtual object among identifiers of at least one second virtual object.

In an aspect, before emphasizing the identifier of the second virtual object that matches a feature (for example, a type, a possessed skill, and a health point) of the first virtual object (for example, a game character A), the terminal device may also perform the following processes: screening, based on a screening rule (for example, screening out a second virtual object having a lowest skill similarity to the first virtual object, or screening out the second virtual object having a minimum health point), the at least one second virtual object (assuming that a game character B, a game character C, and the game character D are included) for the second virtual object (for example, the game character D with the minimum skill similarity as the game character A may be determined as a game character matching the game character A) matching the feature of the game character A; or invoking a machine learning model to perform prediction based on the feature (for example, the possessed skill and the health point) of the at least one second virtual object (assuming that the game character B, the game character C, and the game character D are included), to obtain a score (for example, assuming that the game character B has a score of 80, the game character C has a score of 85, and the game character D has a score of 90) of each second virtual object, and determining the second virtual object (i.e., the game character D) with the highest score as the second virtual object that matches the feature of the game character A. In other words, the terminal device may emphasize an avatar of the game character D among an avatar of the game character B, an avatar of the game character C, and the avatar of the game character D, namely, may recommend the game character D to the user, thereby saving a selection time of the user.

In an example, the machine learning model may be various types of neural networks, for example, a deep neural network. The machine learning model may be trained in a manner of supervised learning. A training sample may be the feature (for example, the possessed skill and the health point) of a virtual object sample, and a corresponding label is a score labeled for the virtual object sample. In a training phase, the machine learning model calculates a prediction score based on the virtual object sample. A difference between the predicted score and a pre-labeled score may be used as an error signal, thereby updating a parameter of the machine learning model based on a backpropagation algorithm.

When emphasizing the identifier of the at least one target second virtual object selected by the first sliding operation, the terminal device may de-emphasize the identifier of the second virtual object that matches the feature of the first virtual object.

In an example in which the first virtual object is the game character A is used. When the terminal device receives a clicking/tapping operation performed by the user for a skill card of the game character A, identifiers of 5 second virtual objects are displayed. Assuming that the identifiers are respectively an avatar of a game character B, an avatar of a game character C, an avatar of a game character D, an avatar of a game character E, and an avatar of a game character F, and assuming that the game character C is a game character that matches the feature of the game character A, the terminal device may emphasize the avatar of the game character C. To be specific, the avatar of the game character C may be in a selected state in advance to be recommended to the user. Assuming that the user does not select the avatar of the game character C recommended by a server subsequently, but selects the avatar of the game character D (for example, the sliding trajectory of the first sliding operation triggered by the user passes through the avatar of the game character D), the terminal device may de-emphasize the avatar of the game character C when emphasizing the avatar of the game character D, to avoid causing interference to the user.

In an aspect, FIG. 5B is a schematic flowchart of an interactive processing method for a virtual scene according to an example of this disclosure. As shown in FIG. 5B, a terminal device may also perform operation 306 shown in FIG. 5B before performing operation 303 shown in FIG. 3. A description is to be given based on operations shown in FIG. 5B.

Operation 306: De-emphasize an identifier of at least one target second virtual object in response to each second pressing operation whose pressure parameter is greater than a pressure parameter threshold, and successively emphasize an identifier of another second virtual object.

Herein, the identifier of the another second virtual object is an identifier of the second virtual object that is not selected by a first sliding operation among the identifiers of the at least one second virtual object, and the second pressing operation is performed on a current contact of the first sliding operation in a case that the first sliding operation is maintained.

In an example in which a first virtual object is a game character A is used. FIG. 4B is a schematic diagram of an application scenario of an interactive processing method for a virtual scene according to an example of this disclosure. As shown in FIG. 4B, skill cards respectively corresponding to a plurality of game characters are displayed in a virtual scene 600. When a terminal device receives a clicking/tapping operation performed by a user on a skill card 605 corresponding to a game character A (the skill card 605 is currently in a theft mode), avatars of 5 other game characters for the game character A to steal skills are displayed in the virtual scene 600, for example, including an avatar 606 of a game character B, an avatar 607 of a game character C, an avatar 608 of a game character D, an avatar 609 of a game character E, and an avatar 610 of a game character F. When a sliding trajectory of an implemented sliding operation passes through the avatar 607 of the game character C in a case that the user maintains a contact of the clicking/tapping operation, the terminal device may emphasize the avatar 607 of the game character C, to represent that the avatar 607 of the game character C is in a selected state. In addition, if the user is not satisfied with the currently selected avatar of the game character, the avatar may also be switched by pressing the currently selected avatar of the game character. For example, when a pressing operation performed by the user on the avatar 607 of the game character C is received, the avatar 607 of the game character C may be de-emphasized, and is switched to emphasizing of an avatar of another game character. For example, when the pressing operation performed by the user on the avatar 607 of the game character C is received for a first time, the avatar 607 of the game character C may be de-emphasized, and the avatar 608 of the game character D is emphasized (namely, a selected state is switched from the avatar 607 of the game character C to the avatar 608 of the game character D). When the pressing operation performed by the user on the avatar 607 of the game character C is received for a second time, the avatar 608 of the game character D may be de-emphasized, and the avatar 609 of the game character E is emphasized (namely, the selected state is switched from the avatar 609 of the game character E to the avatar 608 of the game character D). In other words, each time the user presses the avatar 607 of the game character C, the selected state may be switched to an avatar of a next game character. In this way, the user may switch, only by pressing the same position, the virtual object (i.e., the target second virtual object) from which a skill needs to be stolen, which improves game experience of the user.

In an aspect, after emphasizing the identifier of the at least one target second virtual object selected by the first sliding operation, the terminal device may also perform the following process: performing the following processes for the identifier of each target second virtual object: displaying a skill list of the target second virtual object corresponding to the identifier (for example, an avatar or a name) of the target second virtual object; successively emphasizing each skill in the skill list in response to each third pressing operation for the identifier of the target second virtual object, the third pressing operation being performed on the current contact of the first sliding operation in a case that the first sliding operation is maintained, and the emphasized skill being a target skill (i.e., a skill that the first virtual object is to steal from the target second virtual object); or emphasizing, in response to the second sliding operation for the skill list of the target second virtual object, skills in the skill list (for example, assuming that the skill list includes 4 skills, which are respectively a skill 1, a skill 2, a skill 3, and a skill 4, and assuming that a sliding trajectory of a second sliding operation triggered by the user passes through the skill 2, the skill 2 is determined as the target skill, i.e., the user wants to control the first virtual object to steal the skill 2 possessed by the target second virtual object) through which the sliding trajectory of the second sliding operation has passed, the emphasized skill being the target skill, the second sliding operation being performed from a last contact of the first sliding operation in a case that the first sliding operation is maintained. For example, an example in which the target second virtual object is the game character C is used. As shown in FIG. 4A, when the avatar of the game character C is in the selected state, a skill list of the game character C may be displayed. In this case, the user may perform the second sliding operation from the last contact (i.e., a position where the avatar 604 of the game character C is located) of the first sliding operation in a case that the first sliding operation is maintained. For example, assuming that the sliding trajectory of the second sliding operation triggered by the user passes through a second skill in the skill list, the second skill may be emphasized. To be specific, the terminal device may determine the second skill as a skill (i.e., the target skill) that the game character A needs to steal from the game character C.

In an example in which the target second virtual object is the game character C is used. FIG. 4C is a schematic diagram of an application scenario of an interactive processing method for a virtual scene according to an aspect of this disclosure. As shown in FIG. 4C, when a terminal device emphasizes an avatar 607 of the game character C, a skill list 611 of the game character C may further be displayed in a virtual scene 600. Icons respectively corresponding to 3 skills possessed by the game character C are displayed in the skill list 611, which are respectively an icon 612 of a skill 1, an icon 613 of a skill 2, and an icon 614 of a skill 3. In this case, the user may select, from the skill list 611 by pressing the avatar 607 of the game character C, a skill (i.e., the target skill) to be stolen. For example, assuming that an icon of a first skill (i.e., the icon 612 of the skill 1) in the skill list 611 is in a selected state by default, when the pressing operation performed by the user on the avatar 607 of the game character C is received for the first time, the icon 612 of the skill 1 may be de-emphasized, and the icon 613 of the skill 2 is emphasized (i.e., the selected state is switched from the icon 612 of the skill 1 to the icon 613 of the skill 2). When the pressing operation performed by the user on the avatar 607 of the game character C is received for the second time, the icon 613 of the skill 2 may be de-emphasized, and the icon 614 of the skill 3 is emphasized (i.e., the selected state is switched from the icon 613 of the skill 2 to the icon 614 of the skill 3). In this way, the user may switch, only by performing a pressing operation for the same position, a skill that need to be stolen, which improves game experience of the user.

In an aspect, the target skill may be manually selected by the user, and may also be determined according to a rule. For example, the terminal device may also determine the target skill in the following manners: performing the following processes for each target second virtual object: determining a specific skill (for example, an ultimate skill, i.e., ult) of the target second virtual object as the target skill; determining, as the target skill, a skill released last time by the target second virtual object; and determining, as the target skill, a skill released a maximum number of times by the target second virtual object.

Still referring to FIG. 3, the method also includes the following operation. Operation 304: Control, in response to the first sliding operation being released, the first virtual object to release at least one target skill at a release position of the first sliding operation.

Herein, the at least one target skill is a skill possessed by the at least one target second virtual object.

In an aspect, when a plurality of target skills are provided, the terminal device may implement the controlling the first virtual object to release at least one target skill at a release position of the first sliding operation described above in the following manners: controlling the first virtual object to successively release the plurality of target skills or simultaneously release the plurality of target skills from a range of effect indicated by a skill range indicator control.

For example, 3 target skills are used as an example. For example, assuming that the sliding trajectory of the first sliding operation triggered by the user passes through the avatar of the game character B, the avatar of the game character C, and the avatar of the game character D, the first virtual object (for example, the game character A) controlled by the user is to steal the skills possessed by the game character B, the game character C, and the game character D (for example, it is assumed that the game character A steals the skill 2 from the game character B, steals the skill 3 from the game character C, and steals the skill 4 from the game character D), and the terminal device may control, in response to the first sliding operation being released, the game character A to successively release the skill 2, the skill 3, and the skill 4 in the range of effect indicated by the skill range indicator control, or may control the game character A to simultaneously release the skill 2, the skill 3, and the skill 4.

The terminal device controls the first virtual object to release at least one target skill at the release position of the first sliding operation, which may be to select a position and release the skill regardless of whether a virtual object exists near the position. In addition, when the first virtual object releases the skill (i.e., the target skill) stolen from the target second virtual object, the target second virtual object may temporarily lose the ability to release the target skill. Certainly, the target second virtual object may also continue to release the target skill, which is not specifically limited in the aspects of this disclosure.

In an example, when the target skill has an upper limit for a number of attacks (for example, only 3 virtual objects can be damaged) or energy released by the target skill is fixed (namely, more virtual objects to be attacked by the target skill indicate less influence on each virtual object), the terminal device may also determine a third virtual object affected by the at least one target skill in any one of the following manners: determining, as the third virtual object affected by the at least one target skill, at least one third virtual object (for example, a third virtual object with a smallest health point, or a third virtual object with a lowest defense capability) screened according to a screening rule (for example, screened based on the health point or the defense capability) within the range of effect of the at least one target skill; and invoking a machine learning model to perform prediction based on a feature of the at least one third virtual object (for example, the third virtual object having the highest probability of being affected) within the range of effect of the at least one target skill, to obtain a probability that each third virtual object is affected, and determining, as the third virtual object affected by the at least one target skill, the third virtual object having the probability greater than a probability threshold (for example, the third virtual object having the highest probability of being affected).

In an example in which the target skill is the skill 2 is used. Assuming that the skill 2 has an upper limit for a number of attacks, for example, assuming that the skill 2 can cause damage to only at most 3 game characters, the terminal device may screen the game character within the range of effect of the skill 2 according to the screening rule. For example, a game character having the smallest health point (for example, the game character B) or a game character having the lowest defense capability (for example, the game character C) is screened. In this way, the target skill released by the first virtual object (for example, the game character A) may be controlled to cause damage to only an enemy game character having attack value, which prevents the damage from being evenly distributed, thereby further accelerating the game progress and saving communication resources and computing resources of the terminal device and the server.

In an aspect, when the at least one target skill is a continuously releasable skill (i.e., a skill that can be continuously released a plurality of times), the terminal device may also perform the following process: controlling, in response to a first pressing operation whose pressure parameter is greater than a pressure parameter threshold, the first virtual object to release the at least one target skill at a position where the first pressing operation is performed, the first pressing operation being performed on the current contact (i.e., a point contacting a human-computer interaction interface) of the first sliding operation in a case that the first sliding operation is maintained.

In an example in which the target skill is the skill 2 is used. Assuming that the skill 2 is a skill that can be released a plurality of times (for example, assuming that the skill 2 can be released 3 times), the terminal device not only may control the first virtual object (for example, the game character A) to release the skill 2 at the release position of the first sliding operation, but also may control the game character A to release the skill 2 at a position (i.e., a position at which the first pressing operation is performed) calibrated before the release position. For example, assuming that the user calibrates, during triggering of the first sliding operation, a release position at a position 1 of a virtual scene by applying a pressing operation whose pressure value is greater than a pressure value threshold. Subsequently, the user continues to slide and calibrates another release position at a position 2 of the virtual scene by applying a pressing operation whose pressure value is greater than the pressure value threshold. Finally, the user releases the first sliding operation at a position 3 of the virtual scene. The terminal device may control the game character A to release the skill 2 successively in the position 1, the position 2, and the position 3 of the virtual scene, or may control the game character A to release the skill 2 simultaneously in the position 1, the position 2, and the position 3 of the virtual scene, which is not specifically limited in the aspects of this disclosure. In this way, for the continuously releasable skill, the user may calibrate a plurality of release positions only by preforming one sliding operation, which improves operation efficiency of skill release, thereby saving the communication resources and the computing resources of the terminal device and the server.

In an aspect, when a plurality of target skills are provided, the terminal device may implement the controlling the first virtual object to release at least one target skill at a release position of the first sliding operation described above in the following manners: performing the following process for each third virtual object located within the range of effect with the release position as a center: controlling the first virtual object to successively release the plurality of target skills to the third virtual object; or controlling the first virtual object to release one of the target skills (i.t., not to repeat the attack) to the third virtual object, the target skills released to different third virtual objects being different.

In an example in which 3 target skills are provided is used. For example, it is assumed that the first virtual object (for example, the game character A) steals the skill 2 possessed by the game character B, the skill 3 possessed by the game character C, and the skill 4 possessed by the game character D. When only one game character (for example, the game character E) exists near the release position, the terminal device may control the game character A to successively release the skill 2, the skill 3, and the skill 4 to the game character E. When a plurality of game characters exist near the release position (for example, the game characters include the game character F, a game character G, and a game character H), the terminal device may control the game character A to release a matching skill to each game character. For example, assuming that the game character F has the lowest defense capability, the skill 2 that can further damage the defense capability may be released to the game character F. Assuming that the game character G has the highest magic resistance (i.e., a magic skill cannot cause a lot of damage to the game character G), the skill 3 that can cause physical damage may be released to the game character G. Assuming that the game character H has the highest armor class (i.e., a physical skill cannot cause a lot of damage to the game character H), the skill 4 that can cause magic damage may be released to the game character H. In this way, the target skill is in one-to-one match with the third virtual object, which may ensure the maximum damage on the whole.

In an aspect, the terminal device may also implement the controlling the first virtual object to release at least one target skill at a release position of the first sliding operation described above in the following manners: obtaining a sliding direction when the first sliding operation is released; and controlling the first virtual object to release the at least one target skill in the sliding direction by using the release position of the first sliding operation as a starting point.

In an example in which the target skill is the skill 2 is used. When the terminal device may obtain, in response to the first sliding operation being released, the sliding direction when the first sliding operation is released, and then control the first virtual object (for example, the game character A) to release the skill 2 in the sliding direction with the release position (for example, the position 1 in the virtual scene) of the first sliding operation as a starting point. In this way, by defining a distribution direction of the virtual objects to be attacked and by throwing the virtual objects in the corresponding direction (i.e., the sliding direction), the virtual object in the corresponding direction may be automatically locked and a skill may be released, thereby avoiding a problem that it is time-consuming to drag the virtual object to the corresponding position since the virtual object to be attacked is far away, and further improving the operation efficiency of skill release.

In an aspect, the terminal device may also implement the controlling the first virtual object to release at least one target skill at a release position of the first sliding operation described above in the following manners: obtaining a sliding direction when the first sliding operation is released; and controlling the first virtual object to release, with the release position of the first sliding operation as a starting point, at least one target skill to the third virtual object located within a set angle interval (for example, ±10° with the sliding direction as a center, and assuming that a clockwise direction is a positive direction) with the sliding direction as a center. In this way, by defining a distribution direction of the virtual objects to be attacked and by throwing the virtual objects in the corresponding direction (i.e., the sliding direction), the virtual object in the corresponding direction may be automatically locked and a skill may be released, thereby avoiding a problem that it is time-consuming to drag the virtual object to the corresponding position since the virtual object to be attacked is far away, and further improving the operation efficiency of skill release.

The target second virtual object and the third virtual object in the aspects of this disclosure may be the same virtual object. For example, the first virtual object (for example, the game character A) may steal the skill (for example, the skill 2) possessed by the game character B, and release the skill 2 to the game character B. Certainly, the target second virtual object and the third virtual object may also be different virtual objects. For example, the game character A may steal the skill 2 possessed by the game character B and release the skill 2 to the game character C, which is not specifically limited in the aspects of this disclosure.

In an example, the terminal device may also perform the following process: displaying the sliding trajectory of the first sliding operation by using the contact of the clicking/tapping operation as a starting point. For example, when the terminal device receives the clicking/tapping operation performed by the user for the skill control of first virtual object (for example, the game character A), the sliding trajectory following the first sliding operation triggered by the user is displayed by using the contact of the clicking/tapping operation as the starting point. In this way, the user may clearly understand the target second virtual object (i.e., the virtual object from which a skill needs to be stolen) passed by the sliding trajectory and the release position of the target skill, thereby further improving the operation efficiency of skill release.

According to the interactive processing method for a virtual scene provided in the examples of this disclosure, an attachable two-point sliding operation (one point is configured to determine the target second virtual object, and the other point is configured to determine the release position of the target skill) is designed, so that a player may simultaneously complete stealing and releasing of the skill through one sliding operation. In this way, the operation efficiency of skill release is improved, thereby saving the communication resources and the computing resources of the terminal device and the server.

Next, an example application of this disclosure in an actual application scenario is described by using a strategy card.

In a battle of the strategy card game, it is a common practice to select a skill release target by dragging a skill card (corresponding to the skill control described above) to a target point in a sand table, but this situation generally supports only one round of selection (for example, selecting the target point to be dragged). However, some game characters have special skills, which are divided into a “common skill” and a “stealing skill”. The common skill may be released by normally dragging a skill card once, but the stealing skill needs to be released through two operations. First operation: Select a stealing target (namely, first choose a game character from which a skill is stolen). Second operation: Select a releasing target after the stealing is completed (namely, choose a game character to which the stolen skill is released). Since different stealing skills have different skill range indicators, the player needs to select the release target again after controlling the game character to steal the skill of another game character, and the server is not allowed to release the stolen skill directly to the stealing target by default.

It may be seen that in the solutions provided in the related art, the entire process of releasing the stealing skill requires two clicking/tapping operations and one dragging operation, which is a very long operation process in a fast-paced real-time team battle, resulting in low operation efficiency of skill release. In addition, if a mistake occurs in any of the three operations, the entire process is canceled. In addition, since the entire operation process takes too long, during the operation, a case in which a game character controlled by the player is killed, a stealing target (i.e., an enemy character that wants to steal the skill) is killed, or a releasing target (i.e., an enemy character that releases the stolen skill) is killed may often occur, which leads to cancellation of the operation, a failure of the current operation, and a high failure rate of the operation.

In view of this, according to the interactive processing method for a virtual scene provided in the examples of this disclosure, an attachable two-point dragging operation is designed, so that the player may simultaneously complete the stealing and releasing of the skill through one dragging operation, which shortens an operation process from original 3 operations to 1 operation, and improves the operation efficiency and a success rate of skill release.

The interactive processing method for a virtual scene provided in the examples of this disclosure is described in detail below.

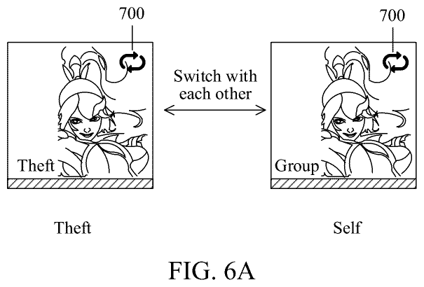

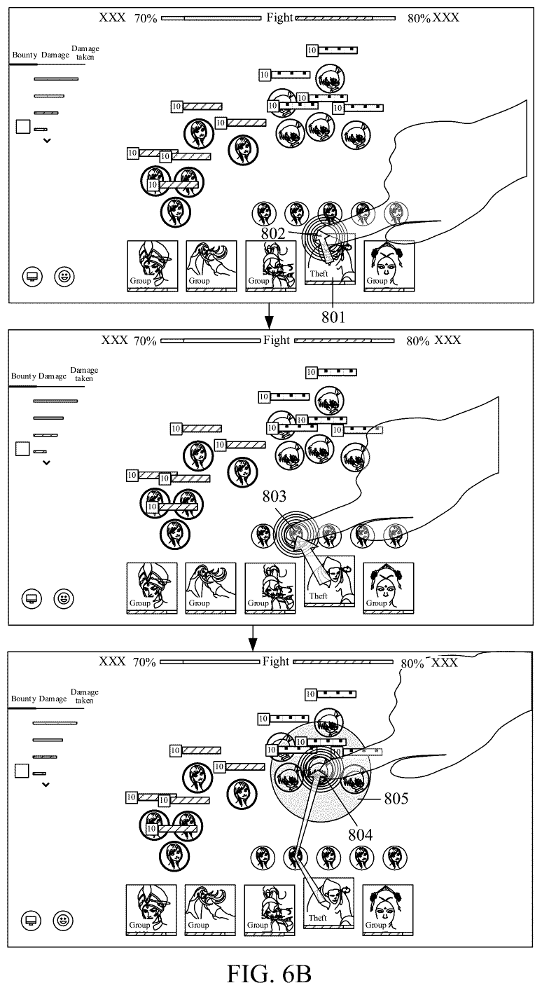

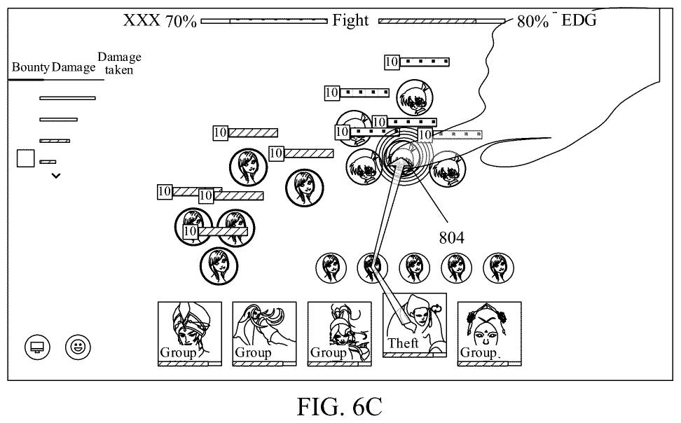

In an aspect, FIG. 6A is a schematic diagram of an application scenario of an interactive processing method for a virtual scene according to an example of this disclosure. As shown in FIG. 6A, in a card face design, an original copy button is canceled and a switch button 700 is canceled. A user may implement switching between a stealing skill and a common skill (including a group skill and a single-target skill, the group skill is used as an example for description in FIG. 6A) by clicking/tapping the switch button 700. For example, when a current mode of a skill card is a theft mode, the skill card may be switched from the theft mode to a self mode after a clicking/tapping operation performed by the user for the switch button 700 is received. In addition, compared with the common skill, since a player has a greater demand for using the stealing skill, a default mode of the skill card may be the theft mode.

In an aspect, FIG. 6B is a schematic diagram of an application scenario of an interactive processing method for a virtual scene according to an aspect of this disclosure. As shown in FIG. 6B, when a player wants to release a stealing skill, the player may directly drag a skill card of a game character having the stealing skill. For example, when a client receives an upward drag operation triggered by the player for a skill card 801, the skill card 801 may be emphasized to represent that the skill card 801 is currently in a selected state. In addition, a dragged guide arrow 802 may also be displayed. Moreover, avatars of 5 game characters are also displayed above the skill card 801, which represent that 5 targets to be stolen may be selected. When the player continues to drag the guide arrow 802 up to 5 options (i.e., the avatars of the game characters), the selected option presents a selected state. For example, assuming that the player drags the guide arrow 802 to a position where an avatar 803 of a game character B is located, the avatar 803 of the game character B presents a selected state. In addition, a point in the middle of the guide arrow 802 is attached to the position where the avatar of the game character B is located, which represents that a stealing target has been selected. In addition, when the player drags a finger back or down, the current selection may be canceled. Subsequently, when the player continues to drag the guide arrow 802 to a sand table, the avatar of the game character touched by the guide arrow 802 presents a selected state, and a specific skill range indicator control of the stealing target may be displayed. For example, assuming that an avatar 804 of a game character C in the sand table touches the guide arrow 802, the avatar 804 of the game character C may be emphasized to represent that the avatar 804 of the game character C is in a selected state. In addition, a skill range indicator control 805 corresponding to the skill stolen from the game character B may also be displayed. Enemy characters within a range of effect (for example, a current selection is stealing an ult of the game character B and releasing the ult to a circle range with the game character C as a center) indicated by the skill range indicator control 805 are all affected by a skill effect. In addition, when the player releases, it is regarded as confirming the release, and moving to the blank or dragging back is regarded as canceling the current selection. When the dragging operation is successfully released, the client first plays a stealing animation, and then plays a skill release animation. The enemy characters within the range of effect indicated by the skill range indicator are all affected by the skill, and the entire operation process ends.

In an aspect, FIG. 6C is a schematic diagram of an application scenario of an interactive processing method for a virtual scene according to an aspect of this disclosure. As shown in FIG. 6C, if a stolen skill is a single-target skill, a skill range indicator has no range of effect during release, and a skill effect only acts on a single target (for example, the skill effect only causes damage to a game character C corresponding to an avatar 804).

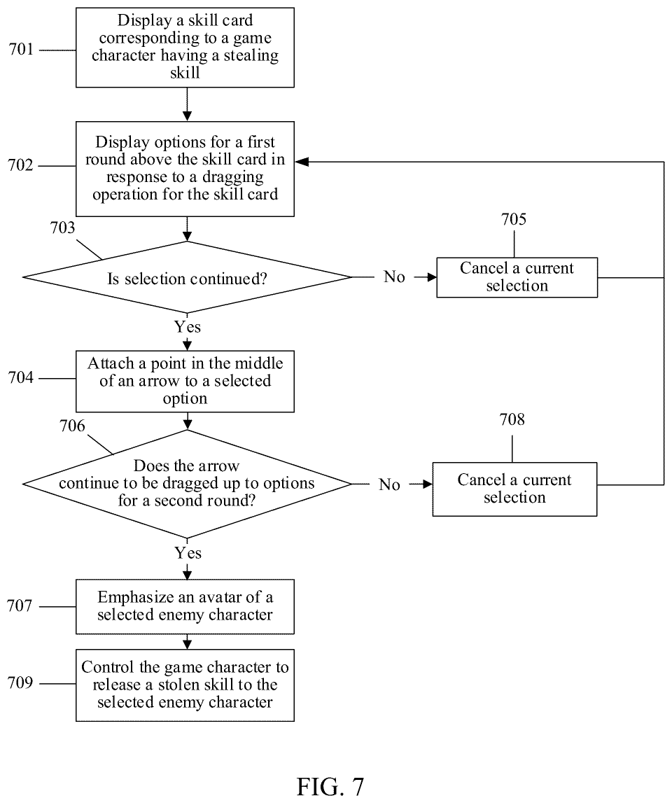

The interactive processing method for a virtual scene provided in this example is described below with reference to FIG. 7.

For example, FIG. 7 is a schematic flowchart of an interactive processing method for a virtual scene according to an aspect of this disclosure. A description is to be given with reference to operations shown in FIG. 7. A client described below is applied to a terminal, which may be a game-specific client installed in the terminal, or may be a game applet installed in another application (for example, an instant messaging client) of the terminal. The game applet is a program that may be immediately used after downloading, and does not need to be installed. The another application is integrated with a browser environment for the game applet to run.

Operation 701: Display, on a client, a skill card corresponding to a game character having a stealing skill.

In an aspect, when the client determines that a player has selected the game character (for example, a game character A) having a stealing skill and has currently entered a team fight stage, the skill card of the game character A may be displayed in the virtual scene, and a default mode of the skill card is a theft mode.

Operation 702: Display, on the client, options for a first round above the skill card in response to a dragging operation for the skill card.

In an aspect, when a player holds down and drags the skill card upward, the skill card may be displayed as a selected state. In addition, when the player drags the skill card upward, a guide arrow may be displayed toward a finger of the player by using the middle of the skill card as a starting point. Moreover, when the skill card is in the selected state, 5 options for a first round of selection may be displayed above the skill card, for example, avatars of 5 enemy characters, which are configured to represent targets that may be stolen.

Operation 703: The client determines whether the player continues to select, if so, performs operation 704, and if not, performs operation 705.

Operation 704: The client attaches a point in the middle of an arrow to a selected option.

In an aspect, when the player drags the arrow to the options for the first round, an option touched by the arrow presents a selected state. For example, assuming that the player drags the arrow to a position where an avatar of a game character B is located, the avatar of the game character B is in the selected state. In addition, a point of the arrow is attached to the selected option (for example, the avatar of the game character B), and the client determines that a selection result for the first round has been determined. For example, assuming that the player drags the arrow to the avatar of the game character B, the client determines that a current operation of the player is stealing a skill of the game character B.

Operation 705: The client cancels a current selection.

In an aspect, when the client detects that the player moves the arrow to the blank and release, it is determined that the current selection is canceled, and the player may drag the arrow again to perform re-selection.

Operation 706: The client determines whether the player continues to drag the arrow up to options for a second round, if so, performs operation 707, and if not, performs operation 708.

Operation 707: The client emphasizes an avatar of a selected enemy character.

Operation 708: The client cancels the current selection.

In an aspect, the player may also perform a second round of selection (i.e., select a releasing target) after selecting a stealing target. When the client detects that the player continues to drag the arrow up to an avatar of a local character in a sand table to perform selection, the avatar of the selected local character presents a selected state. For example, assuming that the client detects that the player continues to drag the arrow up to a position where an avatar of a game character C is located, the avatar of the game character C may be emphasized. To be specific, the client determines that the current operation of the player is releasing the stolen skill to the game character C. Moreover, if the client detects that the player drags the arrow to the blank and release, it is determined that the current selection is canceled.

Operation 709: The client controls the game character to release the stolen skill to the selected enemy character.

In an aspect, the client determines that the player performs the second round of selection based on the first round of selection. For example, assuming that the player selects the game character B and the game character C, the client determines that a final selection result of the player is stealing the skill of the game character B, and releasing the skill to the game character C. After detecting that the player releases, the client determines that releasing is confirmed, and automatically plays an animation of the game character A stealing the skill of the game character B and an animation of releasing the stolen skill to the game character C.

According to the interactive processing method for a virtual scene provided in this disclosure, the interaction through two-point attachable dragging may enable release of a skill in only one dragging operation, which would otherwise need 3 operations, which greatly improves operation efficiency of the operation in a real-time combat and a success rate of skill release, and saves communication resources and computing resources of a terminal device and a server while improving game experience of a user.

An example structure of the interactive processing apparatus 555 for a virtual scene provided in this disclosure implemented as a software module continues to be described below. In an aspect, as shown in FIG. 2, the software module in the interactive processing apparatus 555 for a virtual scene stored in a memory 550 may include a display module 5551 and a control module 5552.

The display module 5551 is configured to display a virtual scene, the virtual scene including skill controls respectively corresponding to a plurality of virtual objects; the display module 5551 being further configured to display an identifier of at least one second virtual object in response to a clicking/tapping operation for a skill control of a first virtual object; the display module 5551 being further configured to emphasize, in response to a first sliding operation for the identifier of the at least one second virtual object, an identifier of at least one target second virtual object selected by the first sliding operation, the first sliding operation being performed from a contact of the clicking/tapping operation in a case that the clicking/tapping operation is maintained; and the control module 5552 being configured to control, in response to the first sliding operation being released, the first virtual object to release at least one target skill at a release position of the first sliding operation, the at least one target skill being a skill possessed by the at least one target second virtual object.

In an aspect, the interactive processing apparatus 555 for a virtual scene further includes a determination module 5553, configured to determine, as the identifier of the at least one target second virtual object selected by the first sliding operation, the identifier of the at least one second virtual object through which the sliding trajectory of the first sliding operation passes.

In an aspect, the determination module 5553 is further configured to determine, as the identifier of the at least one target second virtual object selected by the first sliding operation, the identifier of the at least one second virtual object within a closed region formed by a sliding trajectory of the first sliding operation.

In an aspect, the display module 5551 is further configured to display a skill range indicator control corresponding to the at least one target skill with a current contact of the first sliding operation as a center, the skill range indicator control being configured to indicate a range of effect of the at least one target skill.

In an aspect, the control module 5552 is further configured to control the first virtual object to successively release a plurality of target skills or simultaneously release the plurality of target skills from the range of effect indicated by the skill range indicator control.

In an aspect, the interactive processing apparatus 555 for a virtual scene further includes an obtaining module 5554 configured to obtain a pressure parameter of the first sliding operation. The determination module 5553 is further configured to determine the range of effect of the at least one target skill based on the pressure parameter, a size of the range of effect being positively correlated with the pressure parameter.

In an aspect, the determination module 5553 is further configured to determine, as the range of effect of the at least one target skill, a closed region formed by the sliding trajectory of the first sliding operation in the virtual scene.

In an aspect, when the at least one target skill is a continuously releasable skill, the control module 5552 is further configured to control, in response to a first pressing operation whose pressure parameter is greater than a pressure parameter threshold, the first virtual object to release the at least one target skill at a position where the first pressing operation is performed, the first pressing operation being performed on the current contact of the first sliding operation in a case that the first sliding operation is maintained.

In an aspect, when a plurality of target skills are provided, the control module 5552 is further configured to perform the following process for each third virtual object located within the range of effect with the release position as a center: controlling the first virtual object to successively release the plurality of target skills to the third virtual object; or controlling the first virtual object to release one of the target skills to the third virtual object, the target skills released to different third virtual objects being different.

In an aspect, the obtaining module 5554 is further configured to obtain a sliding direction when the first sliding operation is released. The control module 5552 is further configured to control the first virtual object to release the at least one target skill in the sliding direction by using the release position of the first sliding operation as a starting point.

In an aspect, the determination module 5553 is further configured to determine, in any of the following manners, a third virtual object affected by the at least one target skill: determining, as the third virtual object affected by the at least one target skill, at least one third virtual object screened according to a screening rule within the range of effect of the at least one target skill; and invoking a machine learning model to perform prediction based on a feature of the at least one third virtual object within the range of effect of the at least one target skill, to obtain a probability that each third virtual object is affected, and determining, as the third virtual object affected by the at least one target skill, the third virtual object having the probability greater than a probability threshold.

In an aspect, the obtaining module 5554 is further configured to obtain a sliding direction when the first sliding operation is released. The control module 5552 is further configured to control the first virtual object to release the at least one target skill to a third virtual object located within a set angle interval with the sliding direction as a center by using the release position as a starting point.

In an aspect, the display module 5551 is further configured to de-emphasize, in response to each second pressing operation whose pressure parameter is greater than the pressure parameter threshold, the identifier of the at least one target second virtual object, and successively emphasize an identifier of another second virtual object, the identifier of the another second virtual object being an identifier of the second virtual object that is not selected by the first sliding operation among the identifiers of the at least one second virtual object, and the second pressing operation being performed on the current contact of the first sliding operation in a case that the first sliding operation is maintained.

In an aspect, the display module 5551 is further configured to: emphasize an identifier of a second virtual object that matches a feature of a first virtual object among identifiers of at least one second virtual object; and de-emphasize, when emphasizing the identifier of the at least one target second virtual object selected by the first sliding operation, the identifier of the second virtual object that matches the feature of the first virtual object.

In an aspect, the display module 5551 is further configured to perform the following process for the identifier of each target second virtual object: displaying a skill list of the target second virtual object corresponding to the identifier of the target second virtual object; successively emphasizing each skill in the skill list in response to each third pressing operation for the identifier of the target second virtual object, the third pressing operation being performed on the current contact of the first sliding operation in a case that the first sliding operation is maintained, and the emphasized skill being the target skill; or emphasizing, in response to a second sliding operation for the skill list of the target second virtual object, a skill in the skill list through which a sliding trajectory of the second sliding operation has passed, the emphasized skill being the target skill, and the second sliding operation being performed from a last contact of the first sliding operation in a case that the first sliding operation is maintained.

In an aspect, the determination module 5553 is further configured to perform one of the following processes for each target second virtual object: determining a specific skill of the target second virtual object as the target skill; determining, as the target skill, a skill released last time by the target second virtual object; and determining, as the target skill, a skill released a maximum number of times by the target second virtual object.

In an aspect, the display module 5551 is further configured to emphasize the skill control of the first virtual object, and display a guide identifier, the guide identifier being configured to guide selection of the identifier of the at least one second virtual object.

In an aspect, the skill control of the first virtual object has an expanded mode and a self mode, the expanded mode being a mode that controls the first virtual object to use a skill possessed by another virtual object, the self mode being a mode that controls the first virtual object to release the skill possessed by the first virtual object. The interactive processing apparatus 555 for a virtual scene further includes a switching module 5555, configured to switch the skill control of the first virtual object from the self mode to the expanded mode in response to a mode switching operation for the skill control of the first virtual object.

In an aspect, the display module 5551 is further configured to display the sliding trajectory of the first sliding operation by using the contact of the clicking/tapping operation as a starting point.

The description of the apparatus in the example is similar to the description of the foregoing method example, and has similar beneficial effects as the method. Therefore, details are not described. The technical details that are not covered in the interactive processing apparatus for a virtual scene of this disclosure may be understood according to the description of any one of FIG. 3, FIG. 5A, or FIG. 5B.

An aspect of this disclosure provides a computer program product, the computer program product including a computer program or a computer-executable instruction, the computer program or the computer-executable instruction being stored in a computer-readable storage medium. A processor of a computer device reads the computer-executable instruction from the computer-readable storage medium. The processor executes the computer-executable instruction, so that the computer device performs the interactive processing method for a virtual scene provided in this disclosure.

An aspect of the disclosure provides a computer-readable storage medium, having a computer-executable instruction stored therein, the computer-executable instruction, when executed by a processor, causing the processor to perform the interactive processing method for a virtual scene provided in this disclosure, for example, the interactive processing method for a virtual scene shown in FIG. 3, FIG. 5A, or FIG. 5B.

In an aspect, the non-transitory computer-readable storage medium may be a memory such as a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, a compact disc, or a compact disc read-only memory (CD-ROM), or may be various devices including one or any combination of the foregoing memories.

In an aspect, the executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or other units suitable for use in a computing environment.

In an example, the executable instruction may be deployed to be executed on one electronic device, or executed on a plurality of electronic devices located at one location, or executed on a plurality of electronic devices distributed at a plurality of locations and connected through a communication network.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely examples and are not intended to limit the protection scope of this disclosure. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive. Any modification, equivalent replacement, and improvement made within the spirit and scope of this disclosure all fall within the protection scope of this disclosure.

What is claimed is:

1. An interactive processing method for a virtual scene, the method comprising:
displaying, by an electronic device, a virtual scene, wherein the virtual scene includes a first virtual object;
displaying an identifier of at least one second virtual object in response to a clicking/tapping operation on a skill control of the first virtual object;
in response to a first sliding operation for the at least one second virtual object, indicating an identifier of at least one target second virtual object as selected by the first sliding operation, the first sliding operation being performed by maintaining contact of the clicking/tapping operation; and
controlling, in response to the first sliding operation being released, the first virtual object to release at least one target skill at a release position of the first sliding operation, the at least one target skill being a skill possessed by the at least one second virtual object.

2. The method according to claim 1, the method further comprises:
determining the identifier of the at least one target second virtual object selected by the first sliding operation based on a sliding trajectory of the first sliding operation passes through the at least one second virtual object.

3. The method according to claim 1, the method further comprises:
determining the identifier of the at least one target second virtual object selected by the first sliding operation based on a closed region formed by a sliding trajectory of the first sliding operation.

4. The method according to claim 1, the method further comprises:
displaying, by using a current contact of the first sliding operation as a center, a skill range indicator control corresponding to the at least one target skill, the skill range indicator control being configured to indicate a range of effect of the at least one target skill.

5. The method according to claim 4, wherein a plurality of target skills are provided, the method further comprises:
controlling the first virtual object to release the plurality of target skills one by one or release the plurality of target skills at once from the range of effect indicated by the skill range indicator control.

6. The method according to claim 4, wherein the range of effect of the at least one target skill has an adjustable attribute, the method further comprises:
obtaining a pressure parameter of the first sliding operation; and
determining a size of the range of effect of the at least one target skill based on the pressure parameter.

7. The method according to claim 6, the method further comprises:
de-emphasizing the identifier of the at least one target second virtual object in response to the pressure parameter is greater than a pressure parameter threshold, and
emphasizing an identifier of the second virtual object that is not selected by the first sliding operation among identifiers of the at least one second virtual object.

8. The method according to claim 4, wherein the range of effect of the at least one target skill has an adjustable attribute, the method further comprises:
determining a closed region formed by a sliding trajectory of the first sliding operation in the virtual scene as the range of effect of the at least one target skill.

9. The method according to claim 1, the method further comprising:
performing a machine learning model to predict, based on a feature of at least one third virtual object within a range of effect of the at least one target skill, a probability that each of the at least one third virtual object is affected, and
determining the at least one third virtual object having the probability greater than a threshold as the at least one third virtual object affected by the at least one target skill.

10. The method according to claim 1, the method further comprises:
obtaining a sliding direction of the first sliding operation; and
controlling the first virtual object to release the at least one target skill to a third virtual object located within the sliding direction by using the release position as a starting point.

11. The method according to claim 1, the method further comprises:
emphasizing the identifier of the second virtual object that matches a feature of the first virtual object among the identifiers of the at least one second virtual object; and
de-emphasizing the identifier of the second virtual object that matches the feature of the first virtual object when the at least one target second virtual object selected by the first sliding operation.

12. The method according to claim 1, the method further comprising one of:
determining a specific skill of the target second virtual object as the target skill;
determining, as the target skill, a skill released last time by the target second virtual object; and
determining, as the target skill, a skill released a maximum number of times by the target second virtual object.

13. The method according to claim 1, the method further comprises:
emphasizing the skill control of the first virtual object, and
displaying a guide identifier, the guide identifier being configured to guide selection of the identifier of the at least one second virtual object.

14. The method according to claim 1, the method further comprises:
switching the skill control of the first virtual object from a self mode to an expanded mode in response to a mode switching operation for the skill control of the first virtual object,
wherein the expanded mode being a mode in which the first virtual object is controlled to use a skill possessed by another virtual object, and the self mode being a mode in which the first virtual object is controlled to release a skill possessed by the first virtual object.

15. An apparatus for virtual character state setting, the apparatus comprising:
processing circuitry configured to:
display a virtual scene, wherein the virtual scene includes a first virtual object;
display an identifier of at least one second virtual object in response to a clicking/tapping operation on a skill control of the first virtual object;
in response to a first sliding operation for the at least one second virtual object, indicate an identifier of at least one target second virtual object as selected by the first sliding operation, the first sliding operation being performed by maintaining contact of the clicking/tapping operation; and
control, in response to the first sliding operation being released, the first virtual object to release at least one target skill at a release position of the first sliding operation, the at least one target skill being a skill possessed by the at least one second virtual object.

16. The apparatus according to claim 15, the processing circuitry configured to:
determine the identifier of the at least one target second virtual object selected by the first sliding operation based on a sliding trajectory of the first sliding operation passes through the at least one second virtual object.

17. The apparatus according to claim 15, the processing circuitry configured to:
determine the identifier of the at least one target second virtual object selected by the first sliding operation based on a closed region formed by a sliding trajectory of the first sliding operation.

18. A non-transitory computer-readable storage medium, storing instructions which when executed by a processor cause the processor to perform:
displaying a virtual scene, wherein the virtual scene includes a first virtual object;
displaying an identifier of at least one second virtual object in response to a clicking/tapping operation on a skill control of the first virtual object;
in response to a first sliding operation for the at least one second virtual object, indicating an identifier of at least one target second virtual object as selected by the first sliding operation, the first sliding operation being performed by maintaining contact of the clicking/tapping operation; and
controlling, in response to the first sliding operation being released, the first virtual object to release at least one target skill at a release position of the first sliding operation, the at least one target skill being a skill possessed by the at least one second virtual object.

19. The non-transitory computer-readable storage medium according to claim 18, wherein the instructions when executed by the processor further cause the processor to perform:
determining the identifier of the at least one target second virtual object selected by the first sliding operation based on a sliding trajectory of the first sliding operation passes through the at least one second virtual object.

20. The non-transitory computer-readable storage medium according to claim 18, wherein the instructions when executed by the processor further cause the processor to perform:
determining the identifier of the at least one target second virtual object selected by the first sliding operation based on a closed region formed by a sliding trajectory of the first sliding operation.
